(19) United States
(12) Patent Application Publication
(10) Pub. No.: US 2005/0237753 A1
(43) Pub. Date: Oct. 27, 2005

(54) Light triangle

(76) Inventor: Corey C. Foegen, Gainesville, NY (US)

Correspondence Address: THE BILICKI LAW FIRM, PC, 1285 North Main Street, JAMESTOWN, NY, 14701, US

(21) Appl. No.: 10/832,585

(22) Filed: Apr. 27, 2004

(51) Int. Cl. F21V 35/00

(52) U.S. Cl. 362/392

(57) ABSTRACT

The present invention is a light source holder of a substantially triangular shape. The holder has thirteen settings adapted to receive a light source such as candles and/or oil lamps. The number of settings corresponds to twelve settings for each day of the twelve days of Christmas with the thirteenth light source and setting being a serving source used to light the other light sources. A light source is lit or turned on for each of the twelve days of Christmas. In an embodiment in which a server is unnecessary, i.e., the light source is light bulbs, the light source holder need have only twelve settings.

### FIELD OF INVENTION

The following invention relates generally to candle holders, and more particularly to a candle, oil lamp, or electric light holder in the shape of a triangle that conveys symbolism during holidays such as Christmas.

### BRIEF DESCRIPTION OF THE DRAWINGS

Other aspects of the present invention will appear more clearly upon reading the following description for carrying out the invention, given by way of example and made with reference to the accompanying drawings, in which:

FIG. 1 is a top perspective view of an embodiment of the invention.

FIG. 2A is a top view of an alternate embodiment of the invention.

FIG. 2B is a side view of the same embodiment shown in FIG. 2A.

FIG. 3A is a top view of a second alternate embodiment of the invention.

FIG. 3B is a side view of the same embodiment shown in FIG. 3A.

FIG. 4A is a top view of a third alternate embodiment of the invention.

FIG. 4B is a side view of the same embodiment shown in FIG. 4A.

### DETAILED DESCRIPTION OF EMBODIMENTS OF THE INVENTION

For the purpose of promoting an understanding the present invention, reference is made to embodiments of a light holder, generally triangular in a shape, as illustrated by the drawings. It will nevertheless be understood that no limitations of the scope of the invention are thereby intended. Alterations such as changing the materials used, light sources, or size and dimensions of the structure could provide additional embodiments which would fall within the spirit and scope of the invention, described by way of embodiments herein. Some of the possible embodiments are mentioned in the following detailed description.

With particular reference to the figures, the reader should know that like numerals in different figures refer to the same or similar elements of the embodiments.

In one embodiment of the invention, a candle or light holder, designed to represent the twelve days of Christmas, beginning December 25 and lasting until January 6, the Day of Epiphany, is described. Hereafter, “light sources” will be used to represent candles, oil lamps, or light bulbs. However, this list is not intended to be exhaustive as the apparatus is intended to be compatible with any similar source of light. The light holder is generally of triangular shape and able to hold thirteen light sources such as candles, oil lamps, or electric lights. The apparatus is designed to be reusable and easy to store. In one embodiment, the candle or oil lamp lighting or light placement begins at the base and moves toward the apex of the light triangle.

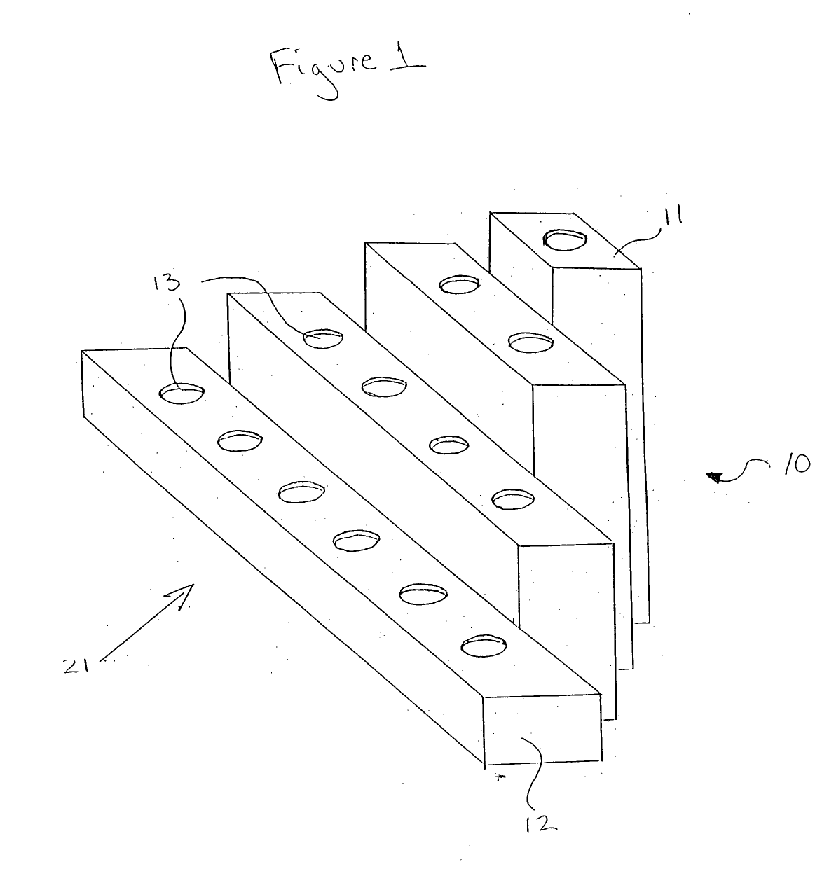

FIG. 1 is a top perspective view of one embodiment of the invention. In all embodiments, a generally triangular shape is used for light holder 10. The triangle is a symbol of the Trinity giving more significance to light holder 10. In this embodiment, light holder 10 is in tiered arrangement and the triangular shape can be appreciated when looking at light holder 10 from front perspective 21. Light holder 10 has thirteen settings 13 which accommodate thirteen light sources such as candles or oil lamps. One setting 13 is for use as a server which is used to light the remaining twelve candles or oil lamps and each of the remaining twelve lights or lamps represents one day of the twelve days of Christmas. The format of light holder 10 is, in the embodiment shown in FIG. 1, as follows: beginning at base 12 of the triangle, there are six settings 13 on the lowest tier, then four settings 13 on the next tier, then two settings 13 on the next tier, and finally one setting 13 at apex 11 or the highest tier of light holder 10. It should be understood that other distributions of settings 13 could be used as long as a substantially triangular shape is retained. It should also be understood that if a light source is used that does not require lighting such as an electric light source, only twelve settings 13 representing the twelve days of Christmas are necessary. In that instance, as with thirteen settings, the precise configuration may vary as long as a substantially triangular shape is retained. The size of light holder 10 is preferentially such that is convenient to store, but still large enough to permit proper viewing of light holder 10 safe burning of oil lamps or candles, and may be much larger to accommodate large light sources for broader public viewing.

The materials used to construct the invention are materials that do not burn when properly used. Such materials include, but are not limited to aluminum, sheet metal, brass, steel, stainless steel, glass, ceramic, stone, plastic, wood, and some synthetic materials, as well as combinations thereof. The horizontal length of each tier is different. Base 12 is the longest, and the top tier at apex 11 is the shortest, with only a single setting 13 at apex 11 of light holder 10. Each tier has at least one setting 13 in which a candle, a votive, vase, or oil lamp can be set. In this embodiment, setting 13 is circular, but it should be understood that the shape of setting 13 is not limited to circles. Other shapes such as, but not limited to, squares and hexagons can be used, so long as setting 13 accommodates the light source.

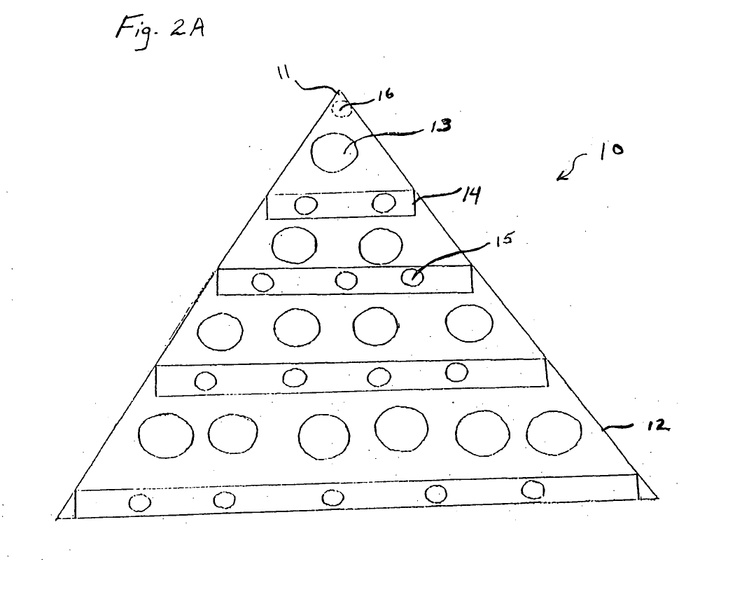

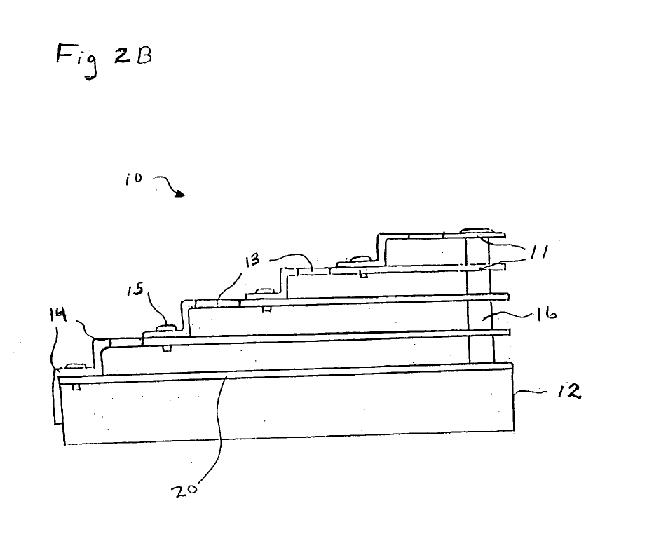

FIGS. 2A and 2B are a top view and a cross-sectional side view of an alternative embodiment of the invention, respectively. Light holder 10 is again of a triangular shape as shown in FIG. 2A and made from sheet metal. Base 12 is made of wood, but can be made of aluminum, sheet metal, brass, steel, stainless steel, glass, ceramic, stone, plastic, wood, and some synthetic materials, as well as combinations thereof. FIG. 2B shows metal sheet 20 folded over base 12 forming step 14. Each metal sheet 20 in the embodiment shown in FIGS. 2a and 2b is triangular in shape with apex 11 and is held in place by rivets 15 at the base of the triangle into which each metal sheet 20 is cut. It should be understood that other mechanisms can be used to hold metal sheets 20 together such as screws, pins, an adhesive, or welding. A different metal sheet 20 is used for each step 14. With each step 14, each metal sheet 20 is at a greater vertical distance from base 12. To maintain the space between metal sheets 20, spacers 16 are between and act as a support for each metal sheet 20, connecting each metal sheet 20 to the one above and/or below it as well as to base 12. Spacer 16 is, in this embodiment, a screw. Each metal sheet 20 is attached to spacers 16 at apexes 11. Each metal sheet 20 has one or more settings 13 to accommodate a light source. The relationship of steps 14, rivets 15, and settings 13 is illustrated.

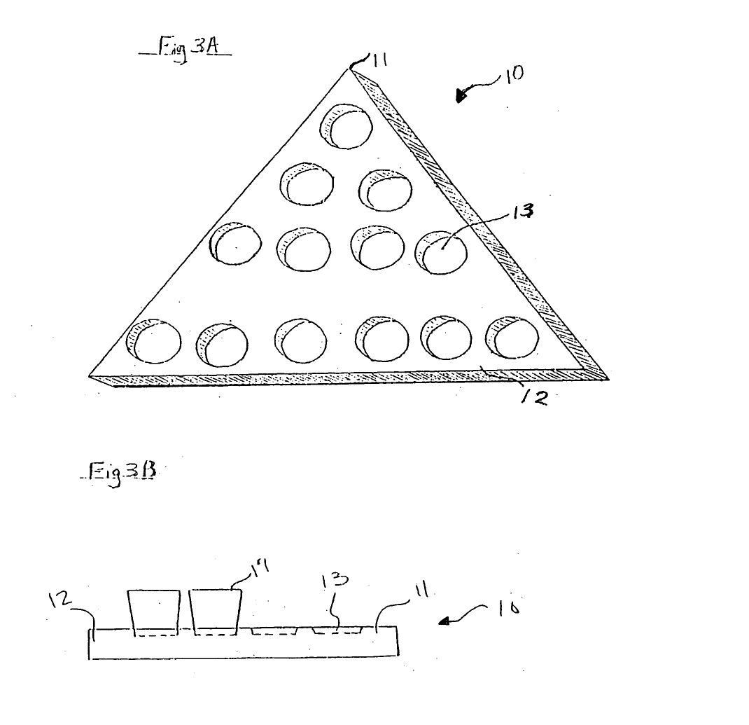

FIGS. 3A and 3B are a top view and a side view, respectively, of a second alternate embodiment of the invention. This embodiment illustrates a flat, triangle-shaped light holder 10 in which all the light sources sit on the same plane. Light holder 10 can be made of wood or other materials, including molded glass, various metals, or synthetic materials, as well as combinations thereof. As shown, light holder 10 accommodates thirteen light sources such as candles or oil lamps within settings 13. In the embodiment shown, one setting 13 is for a server candle or lamp which is used to light the remaining twelve candles or lamps. As in the previous embodiments, each of the twelve lamps represents one day of the twelve days of Christmas. The format of settings 13 is, in this embodiment, as follows: beginning at base 12, a first row of six settings 13, then a second row of four settings 13, then a third row of two settings 13, and finally, a fourth row of one setting 13 at apex 11 of light holder 10. As in other embodiments, it should be understood that other distributions of settings 13 may be used as long as a substantially triangular shape is retained. It should also be understood that if a light source is used that does not require it to be lit with one of the other light sources, such as an electric light source, only twelve settings 13 representing the twelve days of Christmas are necessary. The size of light holder 10 is such that is easy to store, but still large enough to permit safe burning of lamps such as oil or candles.

FIG. 3B shows a side view of the second alternate embodiment shown in FIG. 3A. Settings 13 are shown holding votive vases 17. It can be appreciated from FIG. 3B that settings 13 do not completely penetrate light holder 10. Rather, settings 13 are recesses to accommodate a light source. Settings can, however, be modified to permit use of an electric light bulb as the light source. It should be appreciated that even though light holder 10 is not elevated at apex 11 relative to base 12, a stand (not shown) could be employed to raise apex 11, or candles of different heights could be used to create a rising image.

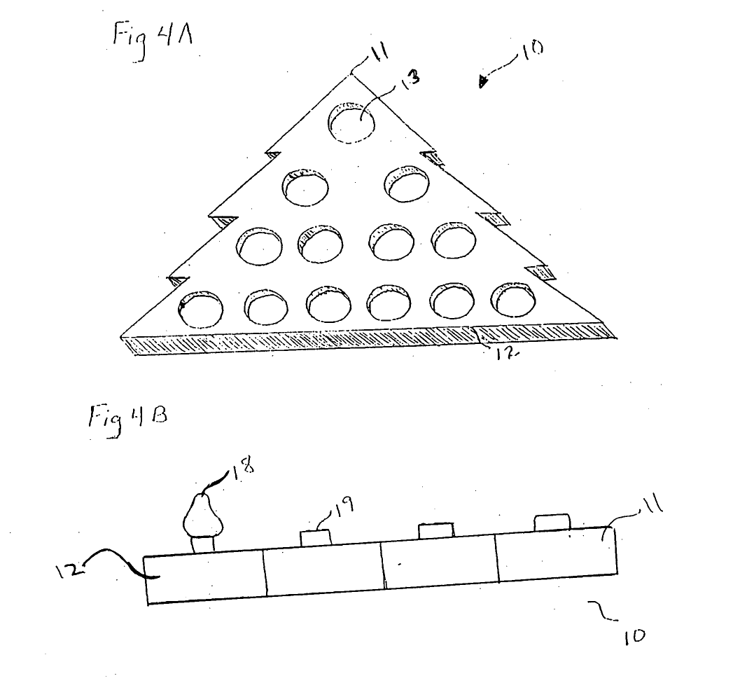

FIGS. 4A and 4B are a front view and a side view, respectively, of a third alternate embodiment of the invention. In this embodiment, as in the previous alternate embodiment, light holder 10 is flat. Light holder 10 is again substantially triangular in shape forming a Christmas tree, as can be seen in FIG. 4A. Settings 13 on light holder 10 are arranged in the same fashion as settings 13 of FIG. 3A. As shown in FIG. 4B, light holder 10 is adapted to receive bulb 18 as the light source. Bulb 18 is set on bulb receiving holder 19 that provides electrical contact to bulb 18. In this embodiment, instead of lighting a candle with each passing day, bulb 18 is connected to light holder 10 via bulb receiving holder 19. It should be appreciated that light holder 10 can be modified to form an uprising structure as shown in FIGS. 1 and 2B. Furthermore, as in the embodiment of FIGS. 3A and 3B, a stand (not shown) can be utilized to raise apex 11. It should also be understood that light holder 10 may also be designed to hold candles or oil lamps instead of bulbs 18.

Although, for convenience, the invention has been described primarily with reference to several specific embodiments, it will be apparent to those of ordinary skill in the art that the valve and the components thereof can be modified without departing from the spirit and scope of the invention as claimed.

1. A substantially triangular-shaped light holder having thirteen settings, wherein each of said thirteen settings is adapted to receive a light source.

2. The light holder of claim 1, wherein said light source is selected from a group comprising: a candle, an oil lamp, and an electric light bulb.

3. The light holder of claim 1, wherein said light holder is made of a material selected from a group comprising: aluminum, sheet metal, brass, stainless steel, steel, glass, ceramic, stone, plastic, wood, synthetic materials, and combinations thereof.

4. The light holder of claim 1, wherein each of said settings is a recess, and wherein each of said recesses is sized to receive said light source.

5. The light holder of claim 1, wherein each of said settings is a hole, and wherein each of said holes is sized to receive one of said light sources.

6. The light holder of claim 1, wherein said light holder is a planar board having a first row of six settings, a second row of four settings, a third row of two settings, and a fourth row of one setting.

7. The light holder of claim 1, wherein said light holder is comprised of:
a first tier with a first top surface, said first top surface having six settings;
a second tier with a second top surface, said second tier being taller than said first tier and said second top surface having four settings;
a third tier with a third top surface, said third tier being taller than said second tier and said third top surface having two settings; and
a fourth tier, said fourth tier being taller than said third tier, forming an apex of said substantially triangular shaped light holder, and having a fourth top surface, said fourth top surface having one setting.

8. The light holder of claim 1, wherein said light holder is shaped substantially like a Christmas tree.

9. The light holder of claim 1, wherein one of said settings acts as a server.

10. A substantially triangular shaped light holder having: a base;
an apex of said substantially triangular shaped light holder; and
thirteen settings, wherein each of said thirteen settings is adapted to receive a light source, said thirteen settings comprised of a first row of six settings at said base, a second row of four settings, a third row of two settings, and a fourth row of one setting at said apex.

11. The light holder of claim 10, wherein said light source is selected from a group comprised of a candle, an oil lamp, and an electric light bulb.

12. The light holder of claim 10, wherein said light holder is made of a material selected from a group comprised of aluminum, sheet metal, brass, stainless steel, steel, glass, ceramic, stone, plastic, wood, synthetic materials, and combinations thereof.

13. The light holder of claim 10, wherein each of said settings is a recess, and wherein each of said recesses is sized to receive one of said light sources.

14. The light holder of claim 10, wherein each of said settings is a hole, and wherein each of said holes is sized to receive one of said light sources.

15. The light holder of claim 10, wherein said light holder is a planar board.

16. The light holder of claim 10, wherein said light holder is comprised of:
a first tier with a first top surface, said first top surface having said first row of six settings;
a second tier with a second top surface, said second tier being taller than said first tier, and said second top surface having said second row of four settings;
a third tier with a third top surface, said third tier being taller than said second tier, and said third top surface having said third row of two settings; and
a fourth tier with a fourth top surface, said fourth tier being taller than said third tier, and said fourth top surface having said fourth row of one setting.

17. The light holder of claim 10, wherein said light holder is shaped substantially like a Christmas tree.

18. The light holder of claim 10, wherein one of said settings acts as a server.

19. A substantially triangular shaped light holder having twelve settings, wherein each of said twelve settings is adapted to receive a light source, said light source selected from a group comprising: a candle, an oil lamp, and an electric light bulb.

20. The light holder of claim 19, wherein said light holder is made of a material selected from a group comprising aluminum, sheet metal, brass, stainless steel, steel, glass, ceramic, stone, plastic, wood, synthetic materials, and combinations thereof.

21. The light holder of claim 19, wherein each of said settings is selected from a group comprising recesses and holes, and wherein each of said settings is sized to receive one of said light sources.

22. The light holder of claim 19, wherein said light holder is a planar board having a first row of at least one setting, a second row of at least one setting, a third row of at least one setting, and a fourth row of one setting.

23. The light holder of claim 19, wherein said light holder is constructed having:
a first tier with a first top surface, said first top surface having at least one setting;
a second tier with a second top surface, said second tier being taller than said first tier, and said second top surface having at least one setting;
a third tier with a third top surface, said third tier being taller than said second tier, and said third top surface having at least one setting; and
a fourth tier having a fourth top surface, said fourth tier being taller than said third tier, and said fourth top surface having one setting.

24. The light holder of claim 19, wherein said light holder is shaped substantially like a Christmas tree.

25. The light holder of claim 19, wherein said light holder is further comprised of a thirteenth setting, said thirteenth setting functioning as a server.
